(19) United States
(12) Patent Application Publication
(10) Pub. No.: US 2006/0001710 A1
(43) Pub. Date: Jan. 5, 2006

(54) Ink cartridge having cleaning solution injecting unit and ink-jet printer having the same

(76) Inventor: Jung-Hwa Lee, Suwon-si (JP)

Correspondence Address: STANZIONE & KIM, LLP, 919 18TH STREET, N.W., SUITE 440, WASHINGTON, DC, 20006, US

(21) Appl. No.: 11/047,579

(22) Filed: Feb. 2, 2005

(30) Foreign Application Priority Data
Jun. 30, 2004 (KR) 2004-50870

(51) Int. Cl. B41J 2/175

(52) U.S. Cl. 347/86

(57) ABSTRACT

An ink cartridge usable with an ink-jet printer includes a case having spaces to store ink and a cleaning solution separately, an ink injecting unit to inject ink, and a cleaning solution injecting unit to inject cleaning solution, wherein the cleaning solution injecting unit is disposed on one side of the ink injecting unit based on a movement direction of a wiping unit of the ink-jet printer. The cleaning solution is injected onto the wiping unit by the cleaning solution injecting unit integrated into the ink cartridge, so that it is possible to simplify the mechanism of the ink-jet printer, to keep a surface of the wiping unit clean, and to increase an efficiency of wiping a surface of ink injecting unit. In particular, a small quantity of cleaning solution is locally injected only onto the wiping unit, so that it is possible to reduce a consumption of the cleaning solution. Further, the cleaning solution does not scatter, so that it is possible to keep a main body of the ink-jet printer clean.

### CROSS-REFERENCE TO RELATED APPLICATIONS

This application claims the benefit under 35 U.S.C. §119 of Korean Patent Application No. 2004-50870 filed on Jun. 30, 2004, the disclosure of which is hereby incorporated herein by reference and in its entirety.

### BACKGROUND OF THE INVENTION

1. Field of the Invention

The present general inventive concept relates to an ink cartridge having an injecting unit to inject a cleaning solution and an ink-jet printer having the same, and more particularly, to an ink cartridge having an injecting unit to inject a cleaning solution used to wipe ink residuals or adhesions stuck to a surface of a head of the ink cartridge as well as a wiping unit to wipe the head, and an ink-jet printer having the ink cartridge.

2. Description of the Related Art

An ink-jet printer refers to an apparatus designed to perform printing by injecting ink in the process of reciprocating an ink cartridge capable of storing and injecting the ink along a width direction of a fed printing medium. The ink cartridge has a bottom surface mounted with a head for injecting the ink. The head has nozzles arranged to permit the ink to be injected, wherein each nozzle has a very small diameter and communicates with an interior of the ink cartridge.

FIG. 1 illustrates a main portion of a conventional ink-jet printer. A carriage 10 is shown in FIG. 1. An ink cartridge 12 is mounted on the carriage 10 and moves left and right along a guide bar 14. The carriage 10 has an upper end fitted into a guide slot 16 to prevent deviation and a bottom surface coupled with a timing belt 18 to be supplied with a driving force from a driving unit.

Meanwhile, a service station is provided on one side of the guide bar 14. Therefore, during or after a printing operation, the carriage 10 moves to the service station. While at the service station, a surface of a head located on a bottom surface of the ink cartridge 12 is wiped by a wiping unit 22. In addition, until a next printing operation is initiated after the printing operation, the head is tightly closed by a capping unit 24, so that the head is prevented from being contaminated. The wiping and capping units 22 and 24 are installed on a frame 20, and are in contact with and separated from the head by moving up and down by a driving member such as a solenoid (not shown).

FIG. 2 illustrates the wiping of the head of the ink cartridge 12 of the ink-jet printer of FIG. 1. Referring to FIGS. 1 and 2, a wiper blade 22b contacts a surface of the head of the ink cartridge 12 to wipe the surface of the head. A wiper holder 22a supports the wiper blade 22b and raises the wiper blade 22b to the surface of the head to start the wiping of the surface.

The wiping unit 22 may be categorized into two driving types based on a relation between a reciprocating direction of the head and a wiping direction of the wiping unit 22: a horizontal type and a vertical type. As shown in FIG. 1, when the reciprocating direction of the head and the wiping direction of the wiping unit 22 are parallel to each other, the wiping unit 22 is referred to as the horizontal type. When the wiping direction of the wiping unit 22 is perpendicular to the reciprocating direction of the head (i.e., in a direction in which the printing medium is fed) in a state in which the head stands still at the service station, the wiping unit 22 is referred to as the vertical type.

The term “wiping” refers to removing foreign materials, such as ink residuals, dusts, etc., attached to the surface of the head of the ink cartridge 12 by moving the wiping unit 22 made of a flexible material such as a rubber, in close contact with the surface of the head of the ink cartridge 12. In this wiping process, the foreign materials are transferred to a surface of the wiping unit 22, thus being stacked on and attached to the surface of the wiping unit 22 in proportion to its operation time. These attached foreign materials deteriorate wiping performance, and are partially inserted into nozzles provided to the head, thus plugging up the nozzles of the head. Particularly, for a color ink cartridge, there is a strong fear of the mixing of colors. Further, the attached foreign materials cause damage to the head surface, so that it is possible to cause a failure of the head.

Particularly, there is a current tendency to use pigment ink rather than dye ink in order to improve printing quality. The pigment ink is a kind of oil-based ink, being insoluble in water when being coagulated. Further, the pigment ink is characterized by better color sensitivity and longer color preservation compared with the dye ink, so that the pigment ink is widely used recently. In spite of these features, the pigment ink is difficult to be wiped compared with the dye ink. For this reason, the pigment ink may suffer from the foregoing problems.

To solve these problems, there has been disclosed an ink-jet printer which cleans a surface of a head by using a cleaning solution independently of ink. That is to say, there are proposals for a method of removing the foreign materials by storing the cleaning solution, sucking the clearing solution into a capping unit and retaining the head in the cleaning solution, or a method of cleaning the head surface by injecting the cleaning solution toward the head surface through an injecting unit to inject the cleaning solution around a service station. All of these methods are adapted to improve a wiping efficiency through the use of the cleaning solution. To this end, the cleaning solution primarily wets the head surface to dissolve the foreign materials, and then the foreign materials are wiped away by a wiping unit. As a result, a wiping performance is improved.

However, these methods spend too much cleaning solution. In particular, in the case of the injection type, the cleaning solution is scattered onto and around the head, thus causing a problem of contaminating its surrounding area. Moreover, these methods require separate components such as an injection pump to have an effect on cleaning the head surface. Therefore, these methods have complicated structures and are not efficient to remove the foreign materials attached to the wiping unit.

### SUMMARY OF THE INVENTION

The present general inventive concept provides an ink cartridge useable with an ink-jet printer, capable of efficiently removing foreign materials attached not only to a head of the ink cartridge, but also to a wiping unit to wipe the head, to thereby prevent damage of the head and increase a wiping efficiency.

The present general inventive concept also provides an ink-jet printer capable of efficiently removing foreign materials attached not only to a head of an ink cartridge therein, but also to wiping unit to wipe the head, so that it is possible to prevent damage of the head and increase a wiping efficiency.

Additional aspects and advantages of the present general inventive concept will be set forth in part in the description which follows and, in part, will be obvious from the description, or may be learned by practice of the general inventive concept.

The foregoing and/or other aspects and advantages of the general inventive concept may be achieved by providing an ink cartridge useable with an ink-jet printer, the ink cartridge including a case having spaces to store ink and a cleaning solution separately, an ink injecting unit to inject the ink, and a cleaning solution injecting unit to inject the cleaning solution, wherein the cleaning solution injecting unit is disposed on one side of the ink injecting unit based on a movement direction of a wiping unit of the ink-jet printer.

The cleaning solution injecting unit can be integrated into the ink cartridge and can directly inject the cleaning solution onto the wiping unit of the ink-jet printer, rather than onto a surface of a head of the ink injecting unit, to thereby clean a surface of the wiping unit.

The cleaning solution may be injected immediately before or after wiping is performed by the wiping unit. When the cleaning solution is injected immediately before the wiping is performed, the cleaning solution injected onto the wiping unit cleans the surface of the wiping means, and then the remaining cleaning solution is transferred to and cleans the surface of the head while the wiping is performed. In contrast, when the cleaning solution is injected immediately after the wiping is performed, foreign materials existing on the surface of the head are transferred to the wiping unit when the wiping is performed, and then the cleaning solution is injected onto the surface of the wiping unit to which the transferred foreign materials are attached. As a result, it is possible to prevent the foreign materials from remaining on the wiping unit.

When the cleaning solution is injected can be determined by a positional relation between the ink injecting unit and the cleaning solution injecting unit. That is, the cleaning solution can be injected immediately before the wiping is performed when the ink injecting unit, the cleaning solution injecting unit and the wiping unit are disposed in that order at a moment when the wiping is performed. The cleaning solution can be injected immediately after the wiping is performed when the cleaning solution injecting unit, the ink injecting unit and the wiping unit are disposed in that order at the moment when the wiping is performed. The cleaning solution injecting unit may be disposed not only on one side, but on both sides of the ink injecting unit so that the cleaning solution can be injected both immediately before and after the wiping is performed to obtain a better result.

The cleaning solution can be directly injected onto the wiping unit, so that the wiping unit may be kept clean. In addition, it is possible not only to increase a wiping efficiency of the head but also to minimize an amount of the cleaning solution scattered around the head, so that a service station of the ink-jet printer may be kept clean as a whole.

The ink and cleaning solution injecting units each may include a plurality of nozzles. An interval between an array of the nozzles of the ink injection unit and an array of the nozzles of the cleaning solution injection unit may be wider than an interval between the arrays of the nozzles of the ink injection unit. This is to scatter the cleaning solution injected before the wiping unit arrives at the ink injecting unit onto the surface of the wiping unit to a sufficient extent.

The present general inventive concept may also be applied to a color ink cartridge. In this case, the ink injecting unit may include a plurality of nozzles to respectively inject ink having a plurality of colors. The color ink cartridge may have inks corresponding to colors of cyan, magenta and yellow. The cleaning solution injecting unit may be disposed between the nozzles of the ink injecting unit corresponding to the brightest color ink, e.g., the yellow color ink, and the wiping unit, and to inject the cleaning solution onto the wiping unit, and to perform the wiping from the nozzles of the ink injecting unit corresponding to the brightest color of ink to the nozzles of the ink injecting unit corresponding to a dark color ink.

When the bright color is mixed with the dark color, an influence of the bright color on the dark color is relatively little compared with an influence of the dark color on the bright color. Particularly, for the vertical type wiping, there is no fear of mixing the colors. Thus, the cleaning solution injecting unit is positioned at the end of the column of the nozzles corresponding to each color.

The ink cartridge case may have an inner space partitioned into reservoirs to store the ink and the cleaning solution by a partition, and the reservoirs may be provided with the ink injecting unit and the cleaning solution injection unit on an inner bottom surface thereof, respectively.

The ink and cleaning solution injecting units each may include a stand pipe attached to each inner bottom surface of the ink cartridge case, a filter attached to an upper end of the stand pipe, and a head provided on each outer bottom surface of the ink cartridge case.

The cleaning solution may include deionized water, and may further include ethylene glycol to produce a more smooth cleaning effect. The ethylene glycol is a hydrophilic material which is well soluble in water and organic solvent. Hence, when the ethylene glycol is added and dissolved, it is conglomerated in a spherical form to form a micelle having a hydrophilic outside and a hydrophobic inside. The micelle is attached to a foreign material, particularly a pigment ink, etc., attached to the wiping unit to facilitate the wiping effectively.

The foregoing aspects and advantages of the present general inventive concept may also be achieved by providing an ink-jet printer including a main body having a driving unit to drive an ink cartridge, the ink cartridge mounted on the main body, a service station having a wiping unit to wipe the ink cartridge, and a controller to control operations of the driving unit, the ink cartridge and the wiping unit.

The wiping unit may include a wiper blade to contact a surface of the ink cartridge and a wiper holder to support the wiper blade and mounted on the service station. The wiper holder may be provided with at least one cleaning solution inlet on a surface opposite to the ink cartridge. The cleaning solution inlet may communicate with a reservoir provided on one side of the main body.

The controller may control the ink cartridge to inject a cleaning solution at least one of immediately before and immediately after wiping depending on the mounted ink cartridge. The cleaning solution injecting unit may be formed on one side or both sides of the ink injecting unit, and the ink cartridge may be adapted to be controlled by the controller. Here, the ink cartridge capable of being mounted according to the ink-jet printer may be determined in advance, so that the controller may control the cleaning solution injecting unit to be suitable for a kind designated in advance. In addition, when information on the kind of the ink cartridge is adapted to be stored in a chip mounted on the ink cartridge, the controller may recognize this information to then control a point of time to inject the cleaning solution according to the kind of the discriminated ink cartridge.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a main portion of a conventional ink-jet printer;

FIG. 2 is a front view illustrating where a wiper blade wipes a head of an ink cartridge in the ink-jet printer of FIG. 1;

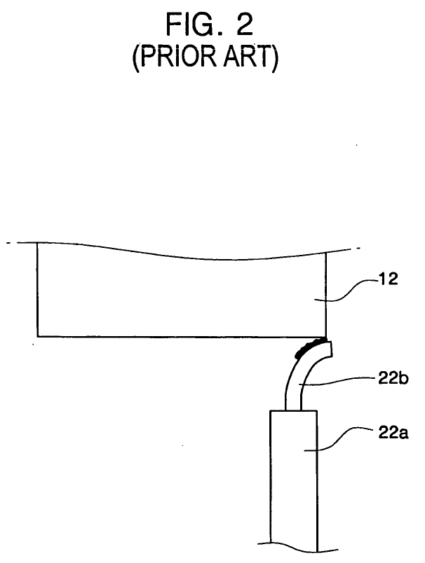

FIG. 3 is a perspective view illustrating an ink cartridge according to an embodiment of the general inventive concept;

FIG. 4 is a cross-sectional view taken along a line A-A of FIG. 3;

FIG. 5 is a perspective view illustrating a main portion of an ink-jet printer having the ink cartridge of FIG. 3;

FIG. 6 is a perspective view illustrating an ink cartridge according to another embodiment of the general inventive concept;

FIG. 7 is a cross-sectional view taken along a line B-B of FIG. 6;

FIG. 8 is a front view illustrating an ink cartridge according to another embodiment of the general inventive concept;

FIG. 9 is a front view illustrating an ink cartridge according to another embodiment of the general inventive concept; and

FIG. 10 is a front view illustrating an ink cartridge according to another embodiment of the general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

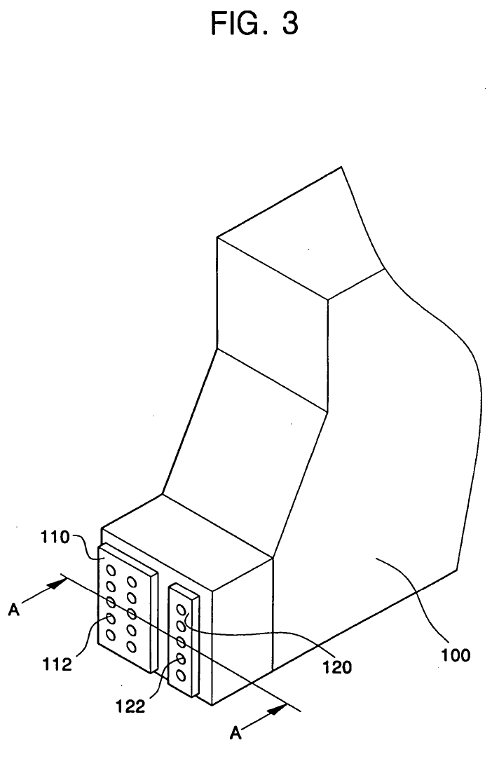

Referring to FIG. 3, an ink cartridge according to an embodiment of the general inventive concept is shown. The ink cartridge is usable with an ink-jet printer having a wiping unit of a horizontal type, and may be applied to a case of performing a wiping operation while the wiping unit (not shown) moves from right to left relative to the ink cartridge of FIG. 3.

The ink cartridge can include a case 100 provided with an internal space to contain ink and a cleaning solution therein. The case 100 can have a bottom surface provided with an ink injection head 110 to inject the ink, and a cleaning solution injection head 120 to inject the cleaning solution. The ink injecting head 110 has a plurality of ink injecting nozzles 112, and the cleaning solution injecting head 120 has a plurality of cleaning solution injecting nozzles 122. Specifically, the ink injecting nozzles 112 can be arranged in two columns, and the cleaning solution injecting nozzles 122 can be disposed on a right side of the ink injecting nozzles 112, and can also be arranged in a column. An interval between the two columns of the ink injecting nozzles 112 can be formed to be narrower than an interval between the column of the cleaning solution injecting nozzles 122 and the neighboring column of the ink injecting nozzles 112.

The cleaning solution may include deionized water or ethylene glycol to produce a more smooth cleaning effect. The ethylene glycol is a hydrophilic material which is well soluble in water and organic solvent. Hence, when the ethylene glycol is added and dissolved, it Is conglomerated in a spherical form to form a micelle having a hydrophilic outside and a hydrophobic inside. The micelle is attached to a foreign material, particularly a pigment ink etc., attached to the wiping unit to facilitate the wiping.

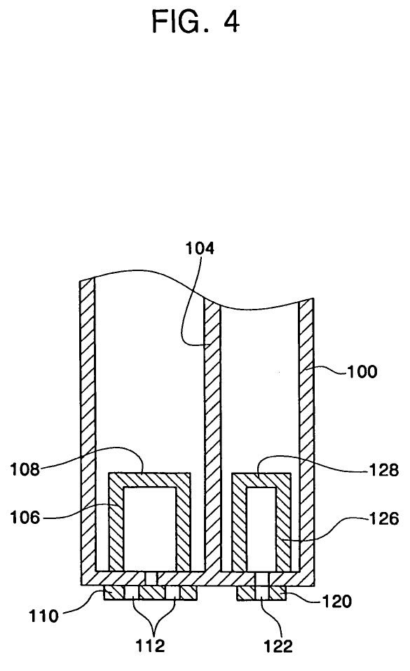

FIG. 4 illustrates an internal structure of the ink cartridge of FIG. 3. Referring to FIGS. 3 and 4, the case 100 is provided with a partition 104. The partition 104 divides the internal space of the case 100 into a first space to store the ink and a second space to store the cleaning solution. Here, a consumption of the cleaning solution can be relatively less than that of the ink. In consideration of this relation, the second space to store the cleaning solution can be set to be relatively small as compared to the first space to store the ink.

The case 100 can have stand pipes 106 and 126 mounted on an internal bottom surface of the first and second spaces. The stand pipes 106 and 126 can have filters 108 and 128, respectively, each of which is attached to an upper portion of each stand pipe 106 or 126. The stand pipes 106 and 126 and filters 108 and 128 are simply one example of, but not limited to, ink injecting units. Therefore, it is apparent to those skilled in the art that the various ink injecting units may be appropriately modified and applied.

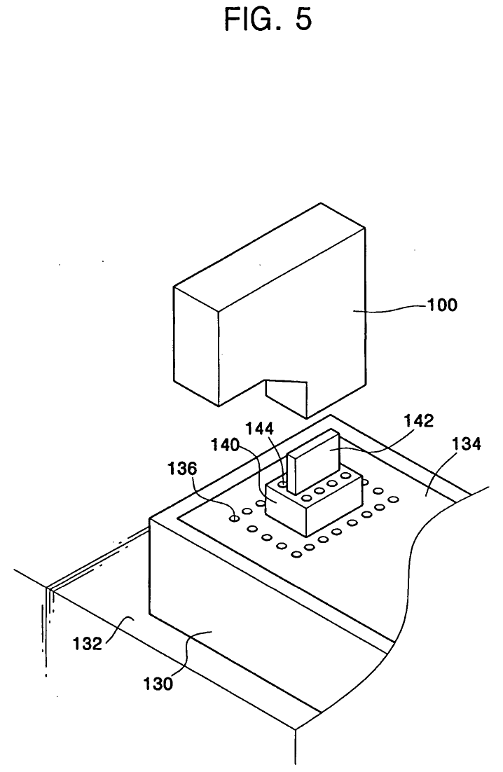

FIG. 5 illustrates a main portion of an ink-jet printer having the ink cartridge of FIG. 3, wherein a rectangular frame 130 can protrude upward from a bottom surface 132 of a main body (not shown) of the ink-jet printer under a service station of the main body. The frame 130 can have a step 134 protruding along an edge on a top surface thereof. A plurality of first cleaning solution inlets 136 into which the cleaning solution flows can be formed around a wiper holder 140 to be described below.

The first cleaning solution inlets 136 collect the cleaning solution injected, and communicate with a reservoir (not shown) to collect the cleaning solution into the reservoir. The reservoir may be disposed either inside the frame or at an arbitrary place in the main body.

The wiper holder 140 can be mounted on the top surface of the frame 130 to be movable up and down. A flexible wiper blade 142 can be fixed to an upper portion of the wiper holder 140. As an elevation mechanism of the wiper holder 140, a known elevation mechanism such as a solenoid may be employed, thus its detailed description will be omitted. Similarly to the first cleaning solution inlets 136 formed in the frame, a plurality of second cleaning solution inlets 144 can be formed around the wiper blade 142 on a top surface of the wiper holder 140. The second cleaning solution inlets 144 can also communicate with the reservoir like the first cleaning solution inlets 136. Thus, the cleaning solution flowing down a surface of the wiper blade 142 can be collected into the reservoir through the second cleaning solution inlets 144 formed in the wiper holder 140 and the first cleaning solution inlets 136 formed in the frame 130. Although FIG. 5 includes both the first and second cleaning solution inlets 136 and 144, the ink-jet printer may have only one of the first and second cleaning solution inlets 136 and 144, as well.

Now, an operation of the ink-jet printer of FIG. 5 will be described. When the ink cartridge is shifted toward the service station by a controller (not shown), the wiper holder 140 is raised to wipe the ink injecting head 110 of the ink cartridge. Just before the wiping, the ink injecting nozzles 112 of the cartridge case 100, the cleaning solution injecting nozzles 122 of the cartridge case 100, and the wiper blade 142 can be positioned in that order from left to right. The controller controls the cleaning solution to be injected toward the surface of the wiper blade 142 through the cleaning solution injecting nozzles 122.

The injected cleaning solution wets the surface of the wiper blade 142, and then the wiper blade is brought into contact with a surface of the ink injecting nozzles 112, i.e., the surface of the ink injecting head 110. In this contact state, the wiper blade 142 goes over the surface of the ink injecting head 110. In this manner, the wiping is performed. Here, the cleaning solution on the surface of the wiper blade 142 allows foreign materials attached to the surface of the ink injecting head 110 to be easily transferred to the surface of the wiper blade 142. Therefore, the foreign materials are dropped down by gravitation and then collected into the reservoir through the first and second cleaning solution inlets 136 and 144 to collect the cleaning solution.

In other words, the foreign materials attached to the surface of the ink injecting head 110 can be transferred to the wiper blade 142 when dissolved or floated by the cleaning solution applied to the wiper blade 142 so that a wiping efficiency may be improved. In addition, because the foreign materials are collected into the separate reservoir without remaining on the surface of the wiper blade 142, the wiper blade 142 is kept clean.

Meanwhile, the cleaning solution injecting head 120 may be disposed on a left side of the ink injecting head 110 rather than the right side thereof. In this case, the wiper blade 142 wipes the surface of the ink injection head 110 first, and thus the foreign materials attached to the ink injecting head 110 are transferred to the wiper blade 142. Then, the cleaning solution is injected toward the surface of the wiper blade 142 to which the foreign materials are attached to thereby separate the foreign materials from the wiper blade 142, and introduce the foreign materials into the reservoir. To be brief, when the wiping of the surface of the ink injecting head 110 is performed after the wiper blade 142 is wetted with the cleaning solution, the wiping efficiency is increased, while an efficiency of cleaning the surface of the wiper blade 142 is relatively decreased. In contrast, when the wiping of the surface of the ink injecting head 110 is performed before the wiper blade 142 is wetted with the cleaning solution, the wiping efficiency is relatively decreased, while the efficiency of the cleaning the surface of the wiper blade is increased.

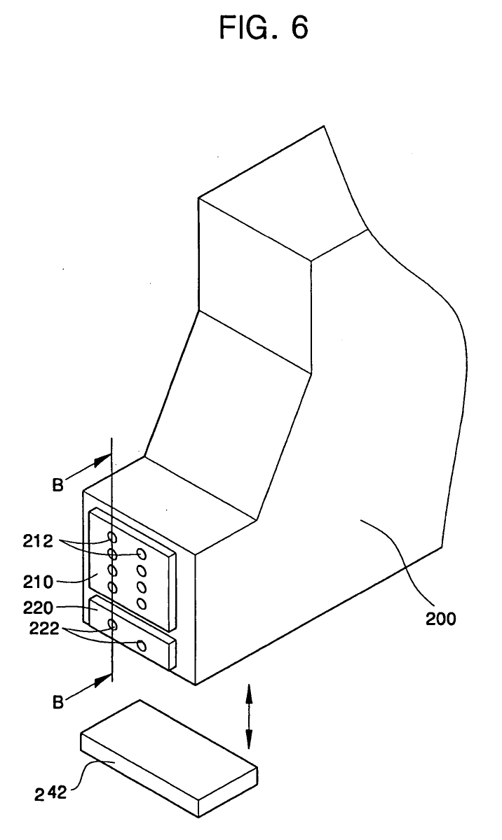

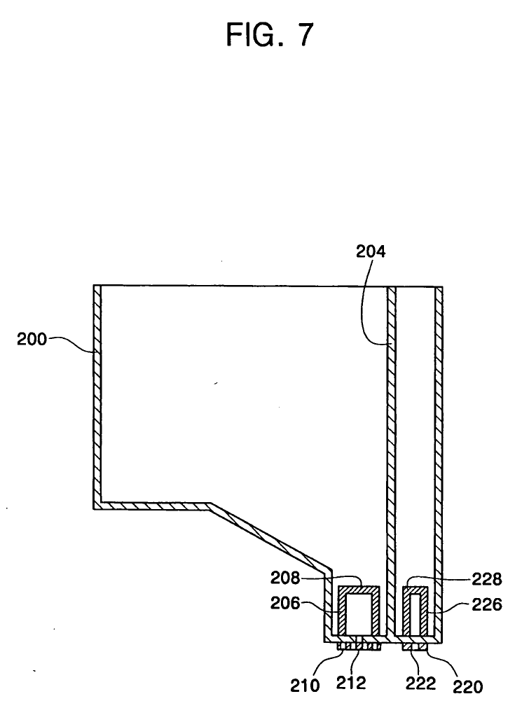

FIGS. 6 and 7 illustrate an ink cartridge according to another embodiment of the general inventive concept. The ink cartridge of FIGS. 6 and 7 is basically similar to the ink cartridge of FIGS. 3 and 4, but different in that wiping is performed in a direction perpendicular to a movement direction of the ink cartridge of FIGS. 6 and 7. That is, the ink cartridge of FIGS. 6 and 7 is directed to an ink cartridge usable with an ink-jet printer having a wiping unit of a vertical type. A wiping blade 242 of the wiping unit is shown in FIG. 6 to illustrate the direction of the wiping.

Referring to FIGS. 6 and 7, a cartridge case 200 having an internal space to store ink and cleaning solution is mounted with an ink injection head 210 to inject the ink and a cleaning solution injection head 220 to inject the cleaning solution on an outer bottom surface thereof. The ink injecting head 210 is provided with a plurality of ink injecting nozzles 212, and the cleaning solution injecting head 220 is provided with a plurality of cleaning solution injection nozzles 222. FIG. 6 illustrates, but the ink cartridge is not limited to, eight ink injecting nozzles 212 and two cleaning solution injecting nozzles 222.

Referring to FIG. 7, the case 200 can be provided with a partition 204. The partition 204 divides the internal space of the case 200 into a first space to store the ink and a second space to store the cleaning solution. The case 200 can have stand pipes 206 and 226 and filters 208 and 228 mounted on a lower portion of the first and second spaces.

An operation of the ink cartridge of FIG. 6 is basically similar to the ink cartridge of FIG. 3, but different in that wiping is performed along the line B-B of FIG. 6 as opposed to the line A-A of FIG. 3. Hence, the operation of the ink cartridge of FIG. 6 is sufficiently similar to the operation of the ink cartridge of FIG. 3 so that a detailed description will be omitted. In this embodiment, it may be considered that the cleaning solution is injected immediately after the wiping is performed, specifically after the wiping is first performed to the ink injection head 210, as described above.

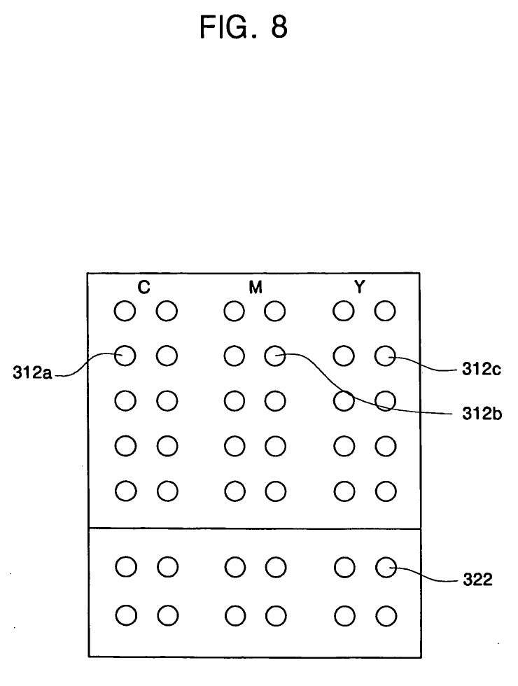

FIG. 8 illustrates an ink cartridge according to another embodiment of the present general inventive concept. The ink cartridge of FIG. 8 is basically similar to the ink cartridge of FIG. 6, but different in that it is directed to an ink cartridge usable with a color printing apparatus. Specifically, the ink cartridge of FIG. 8 includes ink injecting nozzles 312a, 312b and 312c corresponding to a cyan color, a magenta color and a yellow color, respectively, and has cleaning solution injecting nozzles 322 disposed under the ink injecting nozzles. Like the ink cartridge of FIG. 6, the ink cartridge of FIG. 8 is useable with an inkjet printer having a wiping unit of the vertical type. The ink cartridge may include three partitions to divide an internal space into separate sections to accommodate the cleaning solution and the ink corresponding to the cyan color, the magenta color, and the yellow color. Further, the operation of the ink cartridge of FIG. 8 is similar to the operation of the ink cartridge of FIG. 6, and so a detailed description will be omitted.

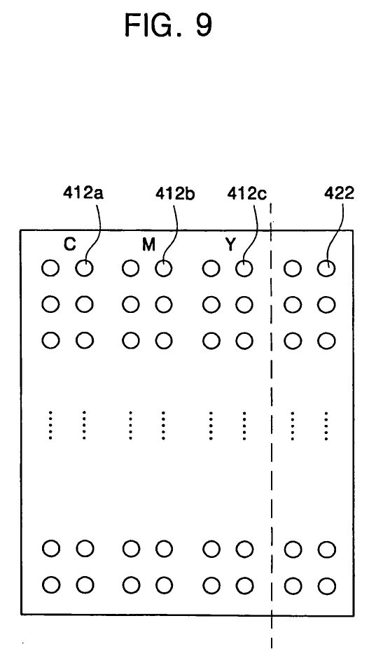

FIG. 9 illustrates an ink cartridge according to another embodiment of the present general inventive concept. The ink cartridge of FIG. 9 is basically similar to the ink cartridge of FIG. 3 but directed, to a color ink cartridge. The ink cartridge of FIG. 9 includes ink injecting nozzles 412a, 412b and 412c corresponding to a cyan color, a magenta color and a yellow color, respectively, and the ink injecting nozzles 412a, 412b and 412c can be arranged in that order from left to right. Cleaning solution injecting nozzles 422 can be arranged on the right side of the yellow ink injecting nozzles 412c.

In other words, when wiping of the horizontal type is performed, a wiper blade goes over the ink injecting nozzles 412a, 412b and 412c while pressing surfaces of the ink injecting nozzles 412a, 412b and 412c. In this case, there is a possibility that the ink of one color will go into the ink injecting nozzle 412a, 412b and 412c corresponding to a different color, so that there is a fear of the mixing of the different colors. When a bright color ink goes into the ink injecting nozzle 412a, 412b and 412c corresponding to a dark color ink, the influence exerted on a color sense of the dark color ink is relatively little (the color is not greatly changed). In contrast, when the dark color ink goes into the ink injecting nozzle 412a, 412b and 412c corresponding to the bright color ink, the influence exerted on the color sense of the bright color ink is relatively great. Thus, when wiping the ink injecting nozzles 412a, 412b and 412c, it is possible to minimize the influence of mixed colors by wiping the brightest color ink first. In particular, the influence from the mixed color may be reduced when the wiping is performed in a state in which the cleaning solution is first injected onto a wiper blade.

The ink cartridge of FIG. 9 can be designed to wipe the ink injecting nozzles 412a, 412b and 412c after the cleaning solution is injected onto the wiper blade. Alternatively, the ink cartridge of FIG. 9 may be implemented in reverse. Namely, the ink injecting nozzles 412a, 412b and 412c may be wiped first, and then the cleaning solution may be injected onto the wiper blade. In this case, it is possible to move the wiper blade over the ink injecting nozzles 412a, 412b and 412c in the order of the yellow, magenta, cyan, and then to the cleaning solution nozzles 422, in order to make allowance for the fear of the mixing of the colors as set forth above.

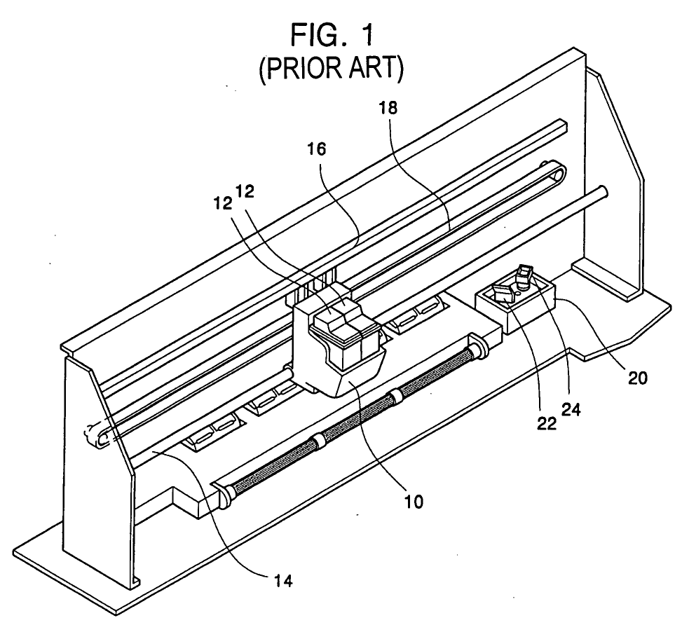

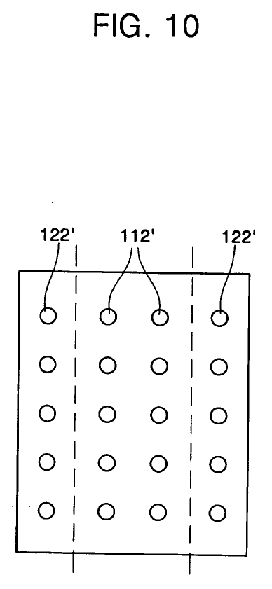

FIG. 10 illustrates an ink cartridge according to another embodiment of the present general inventive concept. The ink cartridge of FIG. 10 is basically similar to the ink cartridge of FIG. 1, and is adapted to improve both a capability to clean a surface of an ink injecting head and a capability to clean a surface of a wiper blade by disposing a plurality of cleaning solution injecting nozzles 122′ on the either side of a plurality ink injecting nozzles 112′. In other words, when wiping the ink injecting nozzles 112′, the cleaning solution is first injected onto the wiper blade surface, and then the ink injecting nozzles 112′ are wiped, and finally the cleaning solution is injected onto the wiper blade surface again. Thus, the wiping efficiency of the surface of the ink injecting head is increased by the cleaning solution remaining on the wiper blade, and the cleaning solution is again injected onto the surface of the wiper blade to which foreign materials are transferred by the wiping, so that the foreign materials attached to the wiper blade may be cleaned away.

The ink cartridge of FIG. 10 is illustrated as being usable with an ink-jet printer having a wiping unit of the horizontal type, but alternatively it may be considered to be usable with an ink-jet printer having a wiping unit of the vertical type. In other words, in the ink cartridge of FIG. 6, the cleaning solution injecting nozzles 222 can be separately disposed on the upper portion of the ink injecting nozzles 212, and thus the cleaning solution may be injected immediately before and after the wiping.

As can be seen from the foregoing embodiments of the present general inventive concept, a cleaning solution is injected onto a wiping unit by a cleaning solution injecting unit integrated into the ink cartridge, so that it is possible to simplify the mechanism of the ink-jet printer, to keep the surface of the wiping unit clean, and to increase an efficiency of wiping a surface of a head.

In particular, a small quantity of cleaning solution is locally injected only onto the wiping unit compared to the prior art, so that it is possible to reduce a consumption of the cleaning solution. Further, the cleaning solution does not scatter, so that it is possible to keep the main body of the printer clean.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink cartridge usable with an ink-jet printer having a wiping unit, comprising:
a case having spaces to store ink and a cleaning solution separately;
an ink injecting unit to inject the ink; and
a cleaning solution injecting unit to inject the cleaning solution,
wherein the cleaning solution injecting unit is disposed on one side of the ink injecting unit based on a movement direction of the wiping unit of the ink-jet printer.

2. The ink cartridge as set forth in claim 1, wherein the ink and cleaning solution injecting units comprise a plurality of ink injecting nozzles and a plurality of cleaning solution injecting nozzles, respectively, and an interval between an array of the ink injecting nozzles of the ink injection unit and an array of the cleaning solution injecting nozzles of the cleaning solution injection unit is wider than that between the arrays of the ink injecting nozzles of the ink injecting unit.

3. The ink cartridge as set forth in claim 1, wherein the ink injecting unit includes a plurality of ink injecting nozzles to respectively inject ink having a plurality of colors including a bright color ink and a dark color ink, and wiping is performed from the ink injecting nozzles corresponding to the bright color ink to the ink injecting nozzles corresponding to the dark color ink after the cleaning solution is injected onto the wiping unit through the cleaning solution injecting unit disposed between the ink injecting unit and the wiping unit.

4. The ink cartridge as set forth in claim 1, wherein the case has an inner space and a partition to partition the inner space into a first reservoir to store the ink and a second reservoir to store the cleaning solution.

5. The ink cartridge as set forth in claim 4, wherein the ink and cleaning solution injecting units each comprise:
a stand pipe attached to each inner bottom surface of the case;
a filter attached to an upper end of the stand pipe; and
a head provided on each outer bottom surface of the case.

6. The ink cartridge as set forth in claim 1, wherein the cleaning solution comprises deionized water.

7. The ink cartridge as set forth in claim 6, wherein the cleaning solution further comprises ethylene glycol.

8. An ink cartridge usable with an ink-jet printer having a wiping unit, comprising:
a case having spaces to store ink and a cleaning solution separately;
an ink injecting unit to inject the ink; and
a cleaning solution injecting unit to inject the cleaning solution,
wherein the cleaning solution injecting unit is disposed on both sides of the ink injecting unit based on a movement direction of wiping unit of the ink-jet printer.

9. An ink-jet printer comprising:
a main body including a driving unit;
an ink cartridge mounted on the main body, driven by the driving unit, and including
a case having spaces to store ink and a cleaning solution separately,
an ink injecting unit formed on the case to inject the ink, and
a cleaning solution injecting unit formed on the case to inject the cleaning solution;
a service station including a wiping unit to wipe the ink cartridge; and
a controller to control operations of the driving unit, the ink cartridge, and the wiping unit.

10. The inkjet printer as set forth in claim 9, wherein the wiping unit comprises a wiper blade to contact a surface of the ink injecting unit of the ink cartridge, and a wiper holder to support the wiper blade and mounted on the service station, the wiper holder having at least one cleaning solution inlet formed thereon.

11. The inkjet printer as set forth in claim 10, wherein the cleaning solution inlet communicates with a reservoir provided on a side of the main body.

12. The inkjet printer as set forth in claim 9, wherein the controller controls the ink cartridge to inject the cleaning solution at least one of immediately before and immediately after the wiping unit wipes the ink cartridge depending on the mounted ink cartridge.

13. An ink cartridge useable with an ink-jet image forming apparatus having a wiping unit to remove foreign particles from the ink cartridge, the ink cartridge comprising:
an ink injecting head to inject ink; and
a cleaning solution injecting head to inject cleaning solution onto the wiping unit of the ink-jet image forming apparatus.

14. The ink cartridge as set forth in claim 13, further comprising:
an ink chamber to store the ink; and
a cleaning solution chamber to store the cleaning solution.

15. The ink cartridge as set forth in claim 14, wherein the cleaning solution chamber is smaller than the ink chamber.

16. The ink cartridge as set forth in claim 13, wherein:
the ink injecting head comprises a plurality of ink injecting nozzles to inject the ink arranged in one or more vertical columns; and
the first cleaning solution injecting head comprises a plurality of cleaning solution injecting nozzles to inject the cleaning solution arranged in one or more vertical column.

17. The ink cartridge as set forth in claim 16, wherein the one or more vertical columns of the cleaning solution injecting nozzles are disposed on a right side of the one or more vertical columns of the ink injecting nozzles.

18. The ink cartridge as set forth in claim 16, wherein the one or more vertical columns of the cleaning solution injecting nozzles are disposed on a left side of the one or more vertical columns of the ink injecting nozzles.

19. The ink cartridge as set forth in claim 16, wherein the one or more vertical columns of the cleaning solution injecting nozzles are disposed above the one or more vertical columns of the ink injecting nozzles.

20. The ink cartridge as set forth in claim 16, wherein the one or more vertical columns of the cleaning solution injecting nozzles are disposed below the one or more vertical columns of the ink injecting nozzles.

21. An ink-jet image forming apparatus comprising:
an ink cartridge to supply ink and a cleaning solution, and including an ink injecting head to inject the ink, and a cleaning solution injecting head to inject the cleaning solution; and
a wiping unit to wipe the ink injecting head to remove foreign materials from the ink injecting head.

22. The image forming apparatus as set forth in claim 21, wherein the wiping unit comprises:
a wiper blade to wipe a surface of the ink injecting head; and
a wiper holder to hold the wiper blade.

23. The image forming apparatus as set forth in claim 22, wherein the wiper holder comprises:
cleaning solution inlets formed on the wiper holder to surround the wiper blade to collect the cleaning solution injected from the cleaning solution injecting head toward the wiper blade.

24. The image forming apparatus as set forth in claim 21, wherein the cleaning solution injecting head injects the cleaning solution towards the wiping unit before the wiping unit wipes the ink injecting head.

25. The image forming apparatus as set forth in claim 21, wherein the cleaning solution injecting head injects the cleaning solution toward the wiping unit after the wiping unit wipes the ink injecting head.

26. The image forming apparatus as set forth in claim 21, wherein the cleaning solution injecting head injects the cleaning solution toward the wiping unit before and after the wiping unit wipes the ink injecting head.
